(19) United States
(12) Patent Application Publication
(10) Pub. No.: US 2024/0407032 A1
(43) Pub. Date: Dec. 5, 2024

(54) WIRELESS COMMUNICATION DEVICE, WIRELESS COMMUNICATION SYSTEM, AND WIRELESS COMMUNICATION METHOD

(71) Applicant: KABUSHIKI KAISHA TOSHIBA, Tokyo (JP)

(72) Inventors: Yuta HIRAI, Setagaya Tokyo (JP); Daisuke UCHIDA, Kawasaki Kanagawa (JP); Kentaro TANIGUCHI, Kawasaki Kanagawa (JP); Koji AKITA, Yokohama Kanagawa (JP); Yuki YONEZAWA, Ayase Kanagawa (JP)

(73) Assignee: KABUSHIKI KAISHA TOSHIBA, Tokyo (JP)

(21) Appl. No.: 18/589,894

(22) Filed: Feb. 28, 2024

(30) Foreign Application Priority Data
May 31, 2023 (JP) 2023-089964

(51) Int. Cl. H04W 76/19; H04W 76/20

(52) U.S. Cl. CPC H04W 76/19; H04W 76/20

(57) ABSTRACT

According to one embodiment, a wireless communication device includes a communication unit and a processor. The processor determines whether a first wireless device is connected to the wireless communication device. When the processor determines connection of the first wireless device, the processor switches a reception frequency of the communication unit among frequencies, and restart periodic communication with the wireless devices after receiving an advertising signal transmitted from the first wireless device.

### CROSS-REFERENCE TO RELATED APPLICATIONS

This application is based upon and claims the benefit of priority from Japanese Patent Application No. 2023-089964, filed May 31, 2023, the entire contents of which are incorporated herein by reference.

### FIELD

Embodiments described herein relate generally to a wireless communication device, a wireless communication system, and a wireless communication method.

### BACKGROUND

As a form of wireless communication, one-to-many wireless communication, in which one wireless communication device communicates with a large number of wireless devices, is performed. An application example of this wireless communication is an IoT system. The IoT system includes a master and a large number of slaves. The master includes a wireless communication device. Each slave includes a wireless device and a sensor. Each slave periodically transmits a sensing result of the sensor to the master. The master receives sensing results which are periodically transmitted from a large number of slaves and generates a control signal relative to each of the slaves. The master transmits a large number of control signals to a large number of slaves, respectively.

In this periodic wireless communication, when the communication between with the wireless device and the wireless communication device is disconnected, it is necessary to reconnect the wireless device in a short time. During the reconnection, wireless communication between the wireless communication device and the wireless device is cut off (in other words, periodical communication is skipped). When reconnection is performed with priority over the communication which is in progress, a delay is caused in the communication which is in progress. Therefore, in an environment where a communication delay is not allowed, communication has to be performed with priority over reconnection.

### BRIEF DESCRIPTION OF THE DRAWINGS

FIG. 1 is a diagram for explaining an example of a wireless communication system according to an embodiment.

FIG. 2 is a diagram for explaining an example of the wireless communication device according to the embodiment.

FIG. 3 is a diagram for explaining an example of communications between the wireless communication device and wireless devices according to the embodiment.

FIG. 4 is a diagram for explaining an example of a reconnection process according to the embodiment.

FIG. 5 is a diagram showing a reference example for explaining a skip of communication caused by a reconnection process.

FIG. 6 shows an example of communication related to a first scan window.

FIG. 7 shows an example of communication related to a second scan window.

FIG. 8 is a diagram showing an example of setting of scan intervals and scan windows according to the embodiment.

FIG. 9 is a diagram for explaining an example of a reception signal strength characteristics.

FIG. 10 is a diagram for explaining an example of setting of scan interval and scan window by the wireless communication device according to the embodiment.

FIG. 11 is a diagram for explaining a cumulative distribution function of a reconnection time by the wireless communication device according to the embodiment.

FIG. 12 is a diagram for explaining another example of setting of the scan intervals and the scan windows by the wireless communication device according to the embodiment.

FIG. 13 is a diagram for explaining yet another example of setting of the scan intervals and the scan windows by the wireless communication device according to the embodiment.

### DETAILED DESCRIPTION

Embodiments will be described below with reference to the drawings. In the following descriptions, a device and a method are illustrated to embody the technical concept of the embodiments. The technical concept is not limited to the configuration, shape, arrangement, material or the like of the structural elements described below. Modifications that could easily be conceived by a person with ordinary skill in the art are naturally included in the scope of the disclosure. To make the descriptions clearer, the drawings may schematically show the size, thickness, planer dimension, shape, and the like of each element differently from those in the actual aspect. The drawings may include elements that differ in dimension and ratio. Elements corresponding to each other are denoted by the same reference numeral and their overlapping descriptions may be omitted. Some elements may be denoted by different names, and these names are merely an example. It should not be denied that one element is denoted by different names. Note that “connection” means that one element is connected to another element via still another element as well as that one element is directly connected to another element. If the number of elements is not specified as plural, the elements may be singular or plural.

In general, according to one embodiment, a wireless communication device includes a communication unit and a processor. The communication unit is configured to periodically communicate with wireless devices in first periods. The processor is configured to determine whether a first wireless device of the wireless devices is connected to the wireless communication device, and when the processor determines that the first wireless device is not connected to the wireless communication device, the processor is configured to switch a reception frequency of the communication unit among frequencies in a second period having a length equal to a length of the first periods, and restart periodic communication with the wireless devices by the communication unit after the communication unit receives an advertising signal transmitted from the first wireless device.

FIG. 1 is a diagram for explaining an example of a wireless communication system according to an embodiment. The wireless communication system includes a wireless communication device 10 and a plurality of (N) wireless devices 12₁, 12₂ . . . 12_{N} configured to wirelessly communicate with the wireless communication device 10, where N is an arbitrary positive integer. For example, the wireless communication system is a Bluetooth Low Energy (BLE) (registered trademark) system. In the following explanation, a wireless communication system in the BLE system is explained. In the BLE system, the wireless communication device 10 is called a master, and each wireless device 12 is called a slave.

An application example of the wireless communication system is a high-power battery device including secondary battery units connected in series and parallel. The battery device could be used for a power storage system. Each secondary battery unit includes a wireless device 12, a temperature sensor, and a voltage sensor. The wireless device 12 periodically transmits a temperature value and a voltage value of the secondary battery unit to the wireless communication device 10. When the temperature value or a voltage value of one secondary battery unit indicates an abnormal value, the wireless communication device 10 transmits an instruction signal to all of the wireless devices 12, stops the output of all of the secondary battery units, and shuts down the battery device. When the temperature value or the voltage value indicates the abnormal value, the shutdown prevents the devices operated by the output of the battery device from abnormally operating because of a malfunction of the battery device.

As the battery device is accommodated in a metallic housing, electromagnetic waves are reflected a plurality of times in the housing. Thus, in wireless communication, in some cases, the rate at which the communication fails in a specific frequency is increased. Therefore, the success rate of wireless communication is lowered. If the communication between the wireless communication device 10 and a wireless device 12 is disconnected at the time points when the wireless device 12 transmits the temperature value and the voltage value, wireless communication does not succeed. In this case, periodic transmission is interrupted, and the wireless communication device 10 cannot detect the abnormality of the secondary battery units. When the communication between the wireless communication device 10 and the wireless device 12 is disconnected, reconnection should be preferably completed in a short time.

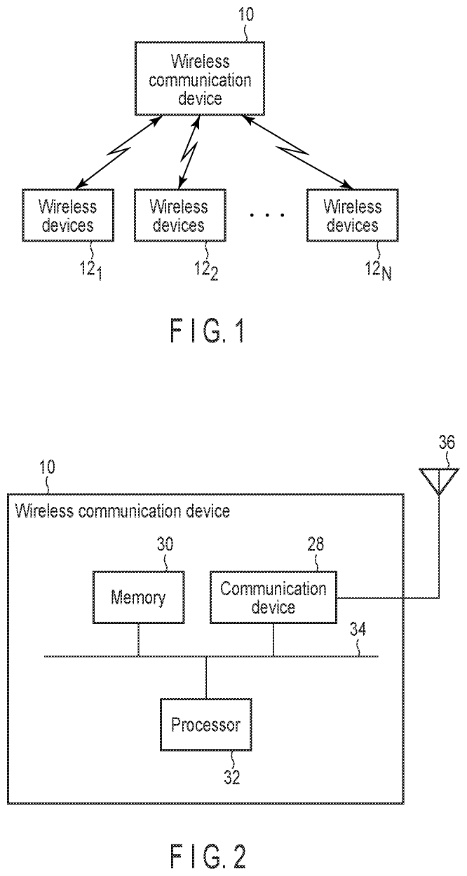

FIG. 2 is a diagram for explaining an example of the wireless communication device 10 according to the embodiment. The wireless communication device 10 includes a communication device 28, a memory 30, and a processor 32. The processor 32 performs a plurality of processes. The processor 32 may be implemented by hardware units which perform processes, respectively, a single hardware unit which performs processes, or a CPU which performs processes. The communication device 28, the memory 30, and the processor 32 are connected to a bus line 34.

The communication device 28 is connected to an antenna 36. The communication device 28 transmits signals to wireless devices 12₁ to 12_{N} respectively and receives signals respectively transmitted from the wireless devices 12₁ to 12_{N}.

The processor 32 writes the identifiers of the wireless devices 12₁ to 12_{N} to the memory 30 by the time when the use of the wireless communication device 10 is started.

The processor 32 communicates with the wireless devices 12₁ to 12_{N} via the communication device 28. The communication may be disconnected during communication. Therefore, the processor 32 determines whether or not the communication is disconnected, in other words, whether or not each of the wireless devices 12₁ to 12_{N} is connected to the wireless communication device 10 at all times. For example, when the communication device 28 does not receives a response from a wireless device 12 for a certain time, the processor 32 determines that the wireless device 12 is not connected to the wireless communication device 10.

In the wireless communication system, reconnection should be performed intentionally in some cases. In this case, the wireless communication device 10 (or wireless device 12) transmits a disconnection request signal to the wireless device 12 (or wireless communication device 10). The processor 32 may determine that, when a disconnection request signal is received, the wireless device 12 is not connected to the wireless communication device 10 and start reconnection.

When an unexpected accident is caused because of an error, the communication may be disconnected. When the error is detected, the processor 32 may determine that the wireless device 12 is not connected to the wireless communication device 10 and start reconnection.

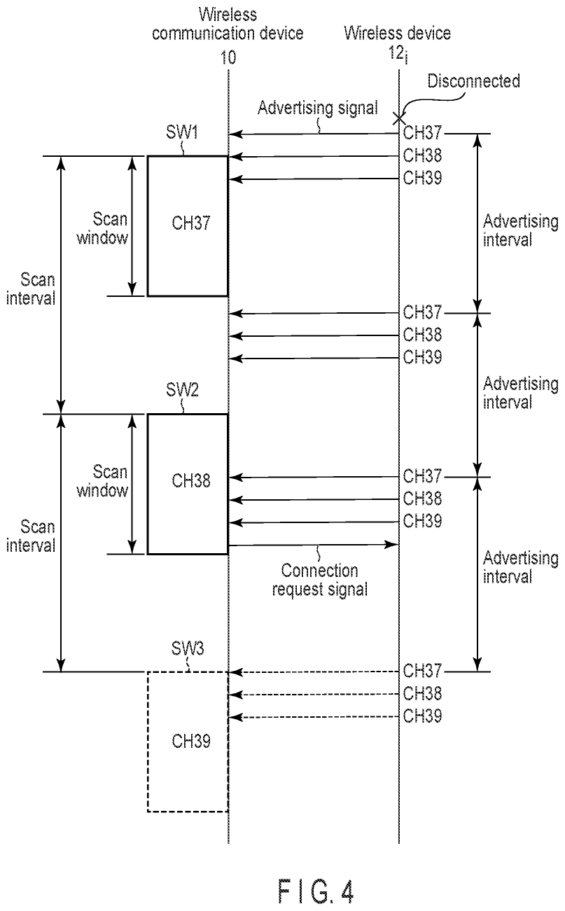

When the processor 32 determines that the wireless device 12ᵢ is not connected to the wireless communication device 10, the processor 32 reconnects the wireless communication device 10 to the wireless device 12ᵢ, where i is an arbitrary positive integer. The details of reconnection are described later with reference to FIG. 4.

Each wireless device 12 is configured in the same manner as the wireless communication device 10. A same device can be applied to the wireless communication device 10 and each wireless device 12. However, each wireless device 12 may not include the memory 30.

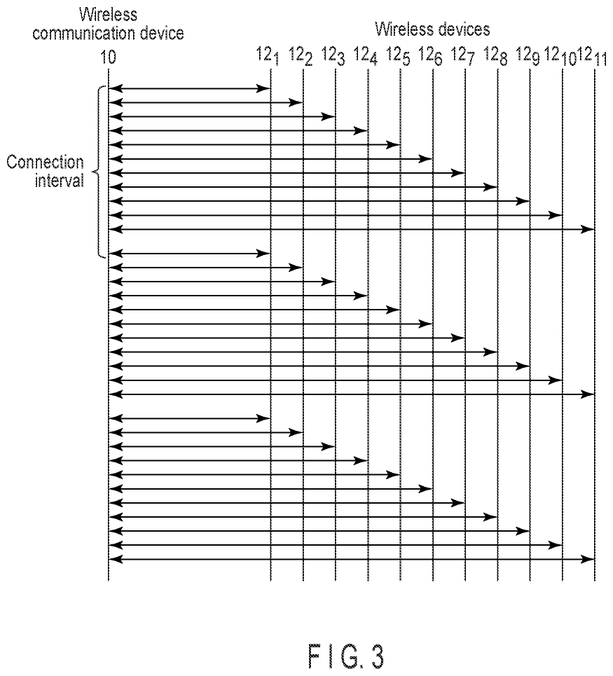

FIG. 3 is a diagram for explaining an example of communications between the wireless communication device 10 and the wireless devices 12₁ to 12_{N} according to the embodiment. For convenience sake, N is assumed to be 11. The wireless communication device 10 periodically performs communication with each of the wireless devices 12₁ to 12₁₁. The period of each cycle of communications between the wireless communication device 10 and the wireless devices 12₁ to 12₁₁ are called a connection interval. The connection interval is also called a first period. Wireless devices 12₁ to 12₁₁ communicate with the wireless communication device 10 in order in the connection interval.

In this manner, the communication time point for each of the wireless devices 12₁ to 12₁₁ is scheduled in advance in each connection interval. These communication time points are not changed basically. When the communication between the wireless device 12ᵢ and the wireless communication device 10 is disconnected, the wireless communication device 10 does not perform communication with the wireless device 12ᵢ and skips the communication.

FIG. 4 is a diagram for explaining an example of a reconnection process which is performed when the communication between the wireless communication device 10 and the wireless device 12ᵢ in the embodiment is disconnected, where i is an arbitrary positive integer from 1 to N.

In the BLE system, the wireless communication band is 2400 MHz to 2480 MHz, and the number of wireless channels is 40. Thirty seven channels, specifically, channel 0 to channel 36, are data channels which communicate data. Three channels, specifically, channels 37, 38, and 39, are advertising channels which communicate advertising packets. Each advertising packet is a packet which is used by the wireless device 12ᵢ to notify the wireless communication device 10 of the name, identifier, transmission power, etc., of the self-device at the time of the start of connection.

Ascending frequencies are allocated to data channel 0 to data channel 36. A frequency which is lower than the data channel 0 is allocated to advertising channel 37. A frequency between the data channels 10 and 11 is allocated to the advertising channel 38. A frequency which is higher than the data channel 36 is allocated to the advertising channel 39.

When the wireless device 12ᵢ determines that the wireless device 12ᵢ is not connected to the wireless communication device 10, the wireless device 12 sets the transmission frequency to the advertising channels 37, 38, and 39, and transmits advertising packets (hereinafter, referred to as advertising signals) to the wireless communication device 10. The wireless device 12ᵢ repeats the transmission of advertising signals by the advertising channels 37, 38, and 39 until reconnection is completed. The transmission cycle of advertising signals is called an advertising interval.

On the wireless communication device 10 side, when the processor 32 determines that the wireless device 12ᵢ is not connected to the wireless communication device 10, the processor 32 performs a reconnection process. Specifically, the processor 32 sets the reception frequency of the communication device 28 to the advertising channels 37, 38, and 39 in series for a certain period. The communication device 28 attempts to receive advertising signals transmitted from the wireless device 12ᵢ by the advertising channels 37, 38, and 39 for the certain period. The certain period is called a scan window. The scan window is also called a second period.

First, the processor 32 sets a first scan window SW1. The processor 32 sets the reception frequency of the communication device 28 to the advertising channel 37 during the first scan window SW1. The communication device 28 attempts to receive an advertising signal transmitted by the advertising channel 37 from the wireless device 12ᵢ during the scan window SW1. The processor 32 identifies the wireless device 12ᵢ which is the transmission source of advertising signal based on the identifier stored in the memory 30.

The wireless device 12ᵢ transmits an advertising signal by one of the advertising channels 37, 38, and 39. The communication device 28 does not necessarily succeed in receiving an advertising signal transmitted by the advertising channel 37 during the scan window SW1. Here, it is assumed that the reception of an advertising signal transmitted by the advertising channel 37 does not succeed during the scan window SW1.

Another wireless device which does not plan to communicate with the wireless communication device 10 may be present near the wireless communication device 10. There is a possibility that the communication device 28 receives an advertising signal transmitted from the other wireless device to another wireless communication device as well. When the communication device 28 receives an advertising signal, the communication device 28 determines from which wireless device an advertising signal is transmitted based on the identifier included in the advertising signal. Therefore, the communication device 28 can receive an advertising signal from the wireless device 12ᵢ which is set so as to communicate with the wireless communication device 10.

When the reception of an advertising signal does not succeed during the scan window SW1, the processor 32 sets a second scan window SW2 after a certain period from the starting time point of the scan window SW1. This certain period, that is, the cycle of the scan window, is called a scan interval.

The processor 32 sets the reception frequency of the communication device 28 to the advertising channel 38 during the second scan window SW2. The communication device 28 attempts to receive an advertising signal transmitted by the advertising channel 38 from the wireless device 12ᵢ during the scan window SW2. Here, it is assumed that the reception of an advertising signal succeeds during the scan window SW2.

When the processor 32 receives an advertising signal via the communication device 28, the processor 32 transmits a CONN-IND packet (hereinafter, referred to as a connection request signal) to the wireless device 12ᵢ via the communication device 28. The processor 32 identifies the wireless device 12ᵢ which is the transmission destination of the connection request signal based on the identifier stored in the memory 30.

When the wireless device 12ᵢ receives a connection request signal, as shown by broken lines of FIG. 4, the wireless device 12ᵢ stops transmitting an advertising signal. When the wireless device 12ᵢ receives a connection request signal, the wireless device 12ᵢ sets the transmission frequency to one of the data channels and starts to communicate with the wireless communication device 10.

The processor 32 stops the setting of a scan window after transmitting a connection request signal to the wireless device 12ᵢ. In the example of FIG. 4, as shown by broken lines, the processor 32 stops the setting of a scan window SW3 in which the reception frequency is the advertising channel 39.

After stopping the setting of the scan window SW3, the processor 32 sets the frequency of the communication device 28 to one of the data channels and restarts the communication with the wireless device 12ᵢ.

When the reception of an advertising signal does not succeed yet during the scan window SW2, the processor 32 sets the third scan window SW3 (the broken lines of FIG. 4) after the certain period from the starting time point of the scan window SW2. The processor 32 sets the reception frequency of the communication device 28 to the advertising channel 39 during the third scan window SW3. The communication device 28 attempts to receive an advertising signal transmitted by the advertising channel 39 during the scan window SW3.

When the reception of an advertising signal does not succeed yet during the scan window SW3, the processor 32 sets a scan window after the certain period from the starting time point of the scan window SW3. In this scan window, the reception frequency of the communication device 28 is set to the advertising channel 37. The processor 32 repeatedly sets a scan window until the communication device 28 succeeds in receiving an advertising signal.

The wireless communication device 10 includes only one antenna 36. The wireless communication device 10 cannot communicate with the wireless device 12ᵢ from when the wireless communication device 10 determines that the wireless device 12ⱼ is not connected to the wireless communication device 10 to when the wireless communication device 10 transmits a connection request signal to the wireless device 12ⱼ. During reconnection, the wireless communication device 10 does not perform communication with the wireless device 12ᵢ and skips the communication. Therefore, this communication is delayed.

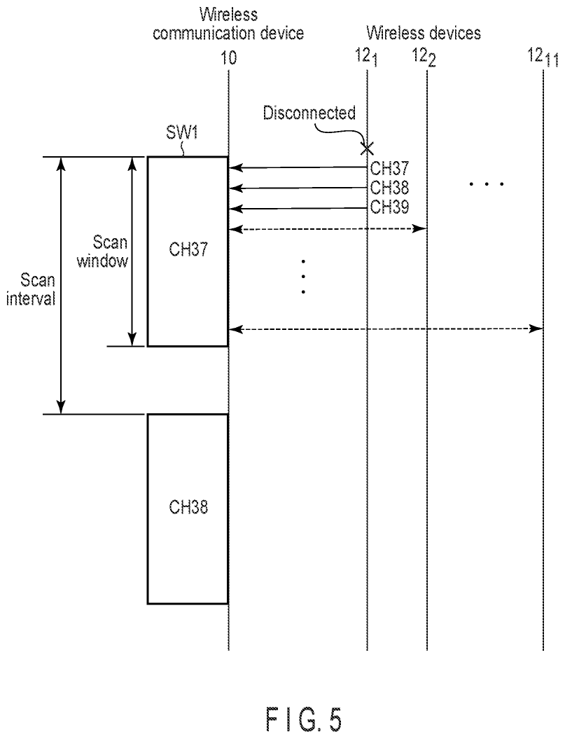

FIG. 5 is a diagram showing a reference example for explaining the skip of communication caused by a reconnection process. When the processor 32 determines that the wireless device 12₁ is not connected to the wireless communication device 10, the processor 32 sets a scan window and performs the reconnection process. If the proportion of the period of the scan window is large relative to the period of the scan interval, the success rate of the reception of an advertising signal can be improved. Thus, the time required until communication is restarted could be shortened.

However, the communications with the wireless device 12₂ to 12₁₁ scheduled in the period of the scan window SW1 are skipped as shown by the broken lines of FIG. 5. As a result, the communications with the wireless devices 12₂ to 12₁₁ are delayed. When the proportion of the period of the scan window is made large relative to the period of the scan interval, the number of communications to be skipped is increased. The increase in the number of communications to be skipped may be a problem in an application which prefers low-latency communication. For example, in an application example of the battery device, the temperature values and the voltage values of all secondary battery units should be preferably transmitted to the wireless communication device at a constant frequency. In some cases, although the skip of communication in one connection interval is allowable, the skip of communication in two successive connection intervals is not allowed.

Thus, it is preferable that both the prevention of the delay of communication with the wireless devices and the execution of reconnection in a short time should be achieved.

To solve this problem, first, when it is determined that the wireless device 12ᵢ is not connected to the wireless communication device 10, the wireless device 12ᵢ preferably transmits advertising signals to the wireless communication device 10 as often as possible. In the case of the BLE system, when a high duty cycle connectable directed advertising mode is set, an advertising interval can be less than or equal to 3.75 ms. By using this mode, advertising signals can be transmitted at a speed higher than the normal advertising interval (20 ms at minimum).

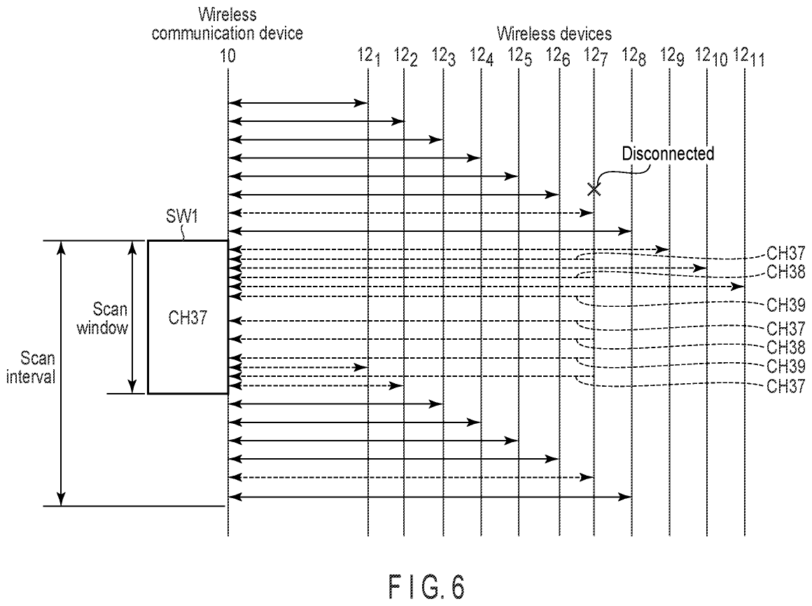

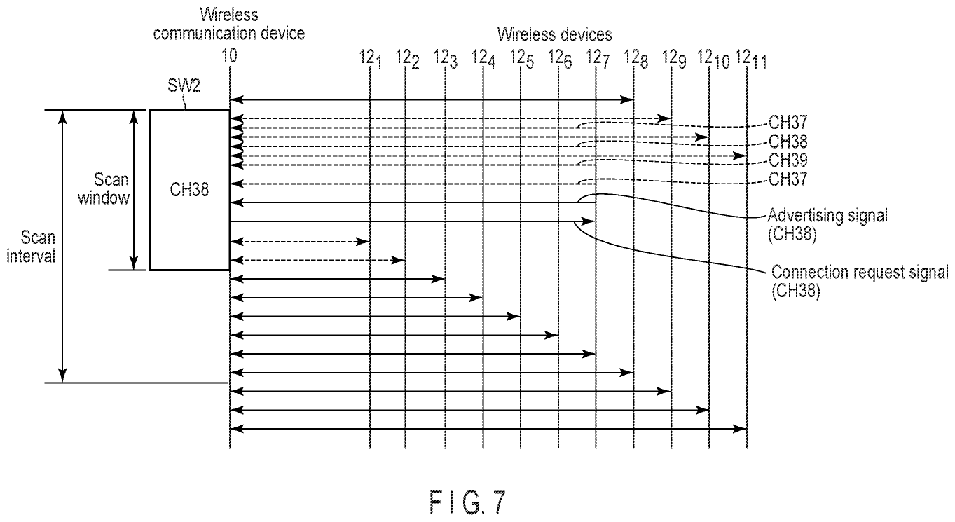

Next, the wireless communication device 10 appropriately adjusts each scan interval and each scan window. FIG. 6 and FIG. 7 are diagrams for explaining the setting of the scan intervals and the scan windows. FIG. 6 and FIG. 7 show a reference example in which a delay occurs in communication with the wireless device 127 as the setting of the scan intervals or scan windows is inappropriate. In the reference example, the scan windows SW1, SW2 . . . are periodically set. FIG. 6 shows an example of communication related to the scan window SW1. FIG. 7 shows an example of communication following FIG. 6 and related to the scan window SW2.

In the wireless communication device 10, when the processor 32 determines that the wireless device 127 is not connected to the wireless communication device 10, the processor 32 sets the scan window SW1 of the advertising channel 37. It is assumed that the processor 32 performs communication with the wireless device 128 before setting the scan window SW1.

The wireless device 127 repeatedly transmits an advertising signal to the wireless communication device 10. The transmission frequency of the wireless device 127 is repeatedly set to the advertising channels 37, 38, and 39.

It is assumed that the processor 32 does not succeed in receiving an advertising signal during the scan window SW. The broken lines of FIG. 6 and FIG. 7 show unsuccessful communications. The processor 32 does not perform communication with any of the wireless devices 12₉ to 12₁₁, 12₁ and 12₂ during the scan window SW1.

The processor 32 sets the second scan window SW2 after the scan interval from the starting time point of the first scan window SW1. It is assumed that the communications between the wireless communication device 10 and the wireless devices 12₃ to 12₆, and 12₈ is performed during the period from the end time point of the first scan window SW1 to the starting time point of the second scan window SW2.

The communication device 28 attempts to receive an advertising signal transmitted by the advertising channel 38 during the second scan window SW2. The processor 32 skips communications between the wireless communication device 10 and the wireless devices 12₉ to 12₁₁, 12₁ and 12₂ during the scan window SW2. It is assumed that the communication device 28 succeeds in receiving an advertising signal during the scan window SW2. When the reception of an advertising signal succeeds, the processor 32 transmits a connection request signal to the wireless device 12₇.

The communications between the wireless communication device 10 and the wireless devices 12₁, 12₂ and 12₉ to 12₁₁ are skipped in both the scan window SW1 and the scan window SW2. Thus, the communications between the wireless communication device 10 and the wireless devices 12₁, 12₂ and 12₉ to 12₁₁ are skipped twice in succession. Thus, the delay time becomes long.

When the scan intervals or the scan windows are not appropriately set, the delay time of communication with a specific wireless device 12 may be long.

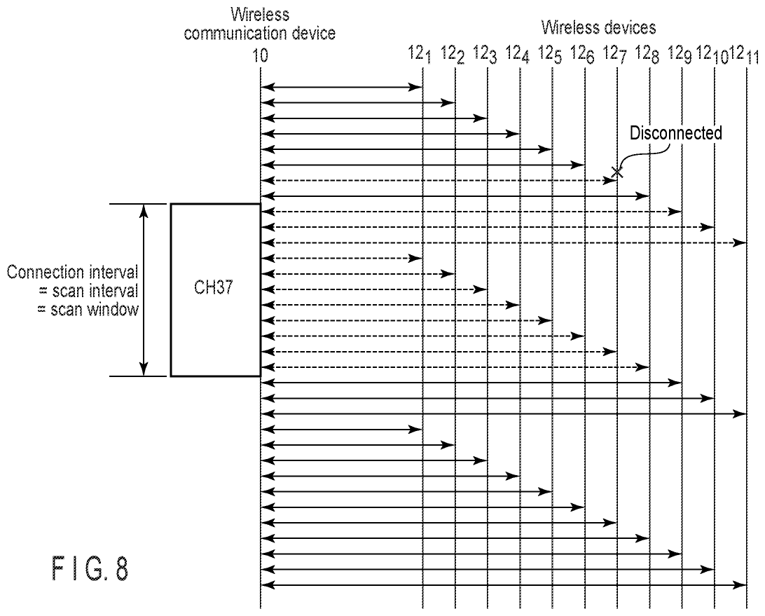

FIG. 8 is a diagram showing an example of the setting of the scan intervals and the scan windows by the wireless communication device 10 according to the embodiment. The processor 32 sets the scan window so as to be equal to the scan interval. Further, the processor 32 sets both of them so as to be equal to the connection interval. Effects obtained from this configuration are explained.

First, as the scan window is equal to the scan interval, the period in which the reception frequency of the communication device 28 is one of the transmission frequencies of an advertising signals becomes long. The success rate of the reception of an advertising signal is increased. Thus, the probability of completion of reconnection of communication with a wireless device 12 in one connection interval from when it is determined that the wireless device 12 is not connected to the wireless communication device 10 is increased.

Next, as the scan window is equal to the connection interval, communication with a specific wireless device 12 is not unfairly skipped. The communication system is configured such that all communications with wireless devices 12 equally skipped once in the connection interval. As the scan window is equal to the connection interval, communication with each of the wireless devices 12 is equally skipped once. In other words, a situation in which, although communication with a wireless device 12 is not skipped, communication with another wireless device 12 is skipped a plurality of times in succession, does not occur.

When the reception of an advertising signal succeeds during the first scan window (in other words, when a connection process is completed during the first scan window), the number of skips of communication with each wireless device 12 whose connection is confirmed can be only one. Thus, the delay in communication can be less.

A case where a reconnection process is not completed during the first scan window is considered. For example, the success rate of communication in a specific channel is low in a closed space with multipath. In the battery device explained as an application example, the wireless communication device and the wireless devices are installed in the metallic housing, i.e., the closed space. In an environment where electromagnetic waves are not obstructed in an open space, and direct waves are dominantly received, the reception signal strength is substantially constant regardless of the frequency. To the contrary, in an environment where the electromagnetic waves reflected in various ways in the closed space are synthesized and received, the reception signal strength changes depending on the frequency.

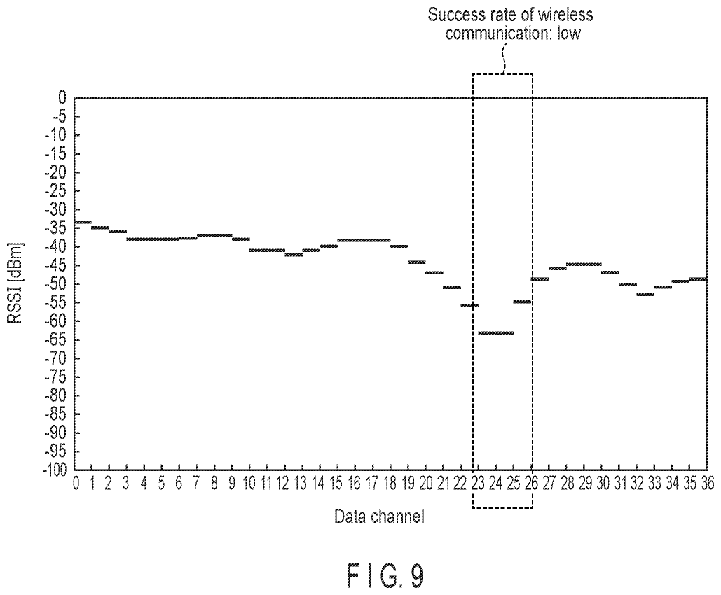

FIG. 9 is a diagram for explaining an example of the reception signal strength characteristics (RSSI: Received Signal Strength Indicator) in a wireless communication system according to the embodiment which undergoes an experiment in the closed space. FIG. 9 shows that the reception signal strengths of channels 24 and 25 are lower than those of the other channels. There are channels in which the success rate of wireless communication is low. Therefore, whether or not a reconnection process is completed during the scan window depends on the reception frequency of the communication device 28 set during the scan window. Regarding a channel in which the set reception frequency has a high success rate in communication, the reconnection process is completed during the first scan window.

Regarding a channel in which the reception frequency set for the first scan window has a low success rate in communication, the possibility that the reception of an advertising signal does not succeed during the first scan window is high. In this case, the second scan window is set, and the reception of an advertising signal is attempted again in another frequency. Thus, the time required until an advertising signal is received is longer. Further, communication is skipped during the second scan window as well. Thus, communication with each wireless device 12 is skipped a plurality of times, and the communication delay is also elongated.

To avoid a situation in which the communication delay is elongated as the success rate in communication in a specific channel is low, it is attempted to receive an advertising signal in all of the channels used for the transmission of an advertising signal during one connection interval.

The processor 32 obtains a sub-period by dividing the connection interval by the number of advertising channels and sets the sub-period to the scan interval and the scan window. For example, when the connection interval is 90 ms, the processor 32 sets the scan interval and the scan window so as to be 30 ms (=90/3).

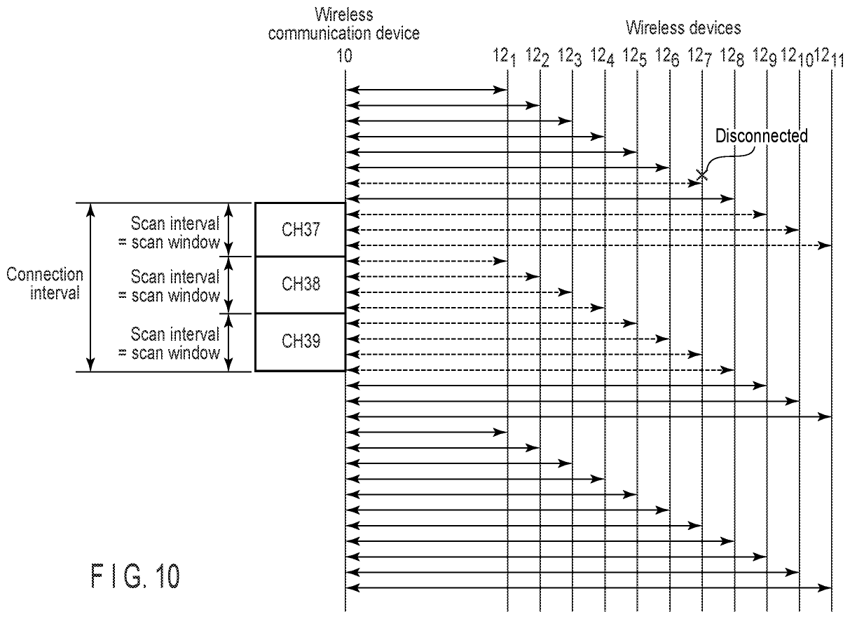

FIG. 10 is a diagram for explaining an example of the setting of the scan interval and the scan window by the wireless communication device 10 according to the embodiment. Three scan intervals are set in one connection interval. Each scan window is set so as to be equal to each scan interval. During the first scan interval, a scan window in which the reception frequency is the advertising channel 37 is set. During the second scan interval, a scan window in which the reception frequency is the advertising channel 38 is set. During the third scan interval, a scan window in which the reception frequency is the advertising channel 39 is set.

Even in the case of the reception signal strength characteristics shown in FIG. 9, the possibility that the success rate in communication is low in all of the three advertising channels is low. For example, it is assumed that the success rate in communication is low in the advertising channels 37 and 38, and the success rate in communication is high in the advertising channel 39. Even if the processor 32 does not succeed in receiving an advertising signal during the first or second scan window, the processor 32 succeeds in receiving an advertising signal during the third scan window, and transmits a connection request signal to the wireless device 12. Thus, the possibility that reconnection is completed during one connection interval is high. In this case, the period in which communication is skipped, in other words, the delay time of communication, is one connection interval at a maximum. Further, communication with each wireless device 12 is equally skipped once during one connection interval.

When the processor 32 succeeds in receiving an advertising signal during the first or second scan window, the processor 32 can restart communication after the completion of the first or second scan window. Thus, the disconnection time of communication is one-third or two-thirds of the connection interval. The time required until communication is restarted is shortened.

The above description explains the case where communication with one wireless device 12 is disconnected. However, the processor 32 performs similar operation in a case where communication with a plurality of wireless devices 12 are disconnected. When the processor 32 determines that a plurality of wireless devices, for example, first and second wireless devices, are not connected to each other, the processor 32 attempts to receive an advertising signal by the advertising channels 37, 38, and 39 during three scan windows of 30 ms, respectively. For example, when an advertising signal from the first wireless device is received during the scan window of the advertising channel 37 (or the advertising channel 38), the processor 32 transmits a disconnection request signal to the first wireless device, and subsequently, attempts to receive an advertising signal from the second wireless device during the scan window of the advertising channel 38 (or the advertising channel 39). For example, when an advertising signal from the second wireless device is received during the scan window of the advertising channel 38 or the scan window of the advertising channel 39, the processor 32 transmits a disconnection request signal to the second wireless device.

When communications with the wireless devices 12 are disconnected in this way, the processor 32 sequentially performs reconnections with the wireless devices 12.

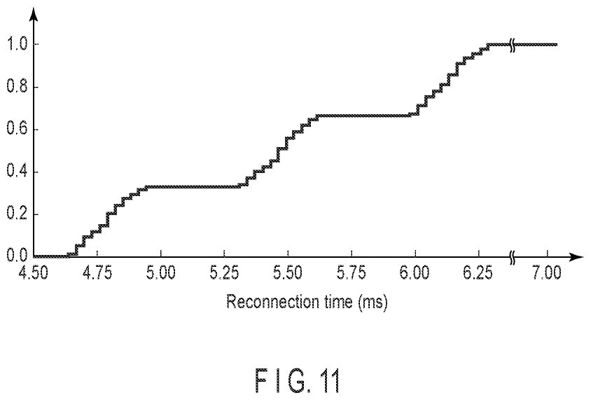

FIG. 11 is a diagram for explaining the cumulative distribution function of the reconnection time by the wireless communication device 10 according to the embodiment. FIG. 11 shows the reconnection time in a case where scan intervals and the scan windows are set as shown in FIG. 10. The reconnection time is the time required from the time when the processor 32 determines that the wireless device 12ᵢ is not connected to the wireless communication device 10 until the time when the processor 32 transmits a connection request signal to the wireless device 12ᵢ.

As a reconnection process is completed in 7 ms in all cases, there is no problem if each scan window and each scan interval is greater than or equal to 7 ms. In the example of FIG. 10, each scan window and each scan interval is set to 30 ms. Therefore, reconnection with all of the wireless devices 12 which need reconnection is completed during the first scan window of the advertising channel 37.

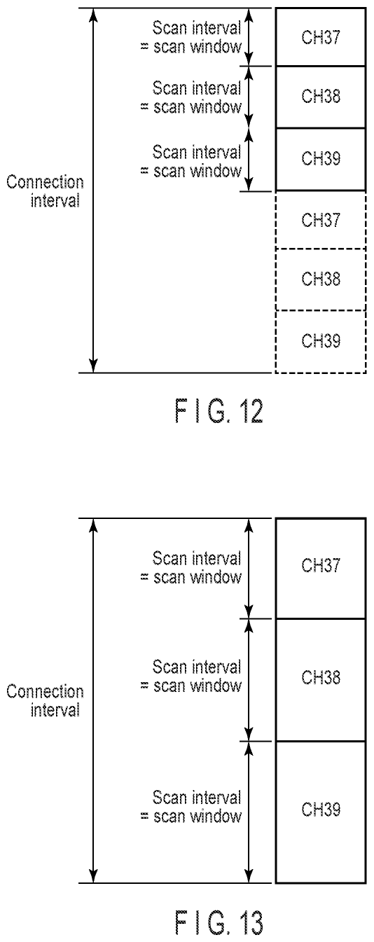

FIG. 12 is a diagram for explaining another example of setting of the scan intervals and the scan windows by the wireless communication device 10 according to the embodiment. When it is known that the reconnection time is relatively short as 7 ms, the time required until communication is restarted can be further shortened. The processor 32 obtains a sub-period by dividing the connection interval by an arbitrary integer (k) multiple of the number (m) of advertising channels. For example, when the connection interval is 90 ms, the processor 32 sets each scan interval and each scan window so as to be 15 ms (=90/(2×3)). Here, k is 2.

The total time length of the three scan intervals is half the time length of the connection interval. By this configuration, the reception of an advertising signal can be attempted in 45 ms (three scan windows) at earliest.

It should be noted that the total time length of three scan intervals is not limited to half the time length of the connection interval and may be at least shorter than the time length of the connection interval.

FIG. 13 is a diagram for explaining yet another example of setting of the scan intervals and the scan windows by the wireless communication device 10 according to the embodiment. In the examples of FIG. 10 and FIG. 12, the time lengths of all of the scan intervals are equal to each other. In the example of FIG. 13, scan intervals (=scan windows) which are not equal to each other are set. For example, the time length of the scan window of the advertising channel 37 is 15 ms. The time length of the scan window of the advertising channel 38 is 25 ms. The time length of the scan window of the advertising channel 39 is 50 ms.

Further, in the example of FIG. 13, the time lengths of two of the scan windows may be equal to each other. For example, the time lengths of the scan windows of the advertising channels 37 and 38 may be 25 ms, and the time length of the scan window of the advertising channel 39 may be 40 ms.

FIG. 13 can be modified as shown in FIG. 12. In other words, the total time length of three scan intervals may be shorter than the time length of the connection interval.

Now, modified examples of the wireless communication device 10 will be explained.

Three channels 37, 38, and 39 are used as advertising channels for transmitting advertising signals. However, other three channels may be used. Further, the number of advertising channels is not limited to three, and may be one or two, or may be four or more.

The wireless communication device 10 or the wireless device 12ᵢ can change the number and/or frequencies of the advertising channels. When they are changed, the wireless communication device 10 (or wireless device 12ᵢ) notifies wireless device 12ᵢ (or wireless communication device 10) of the number and/or frequencies of the advertising channels. The wireless communication device 10 notified of the number and/or frequencies of the advertising channels by wireless device 12ᵢ may write them to the memory 30. The wireless communication device 10 can prevent the setting of a useless scan window by recognizing the number and/or frequencies of the advertising channels. The useless scan window is a scan window which attempts to receive an advertising signal by a channel which is not an advertising channel. In addition, the wireless communication device 10 can prevent a situation in which a scan window for attempting to receive an advertising signal transmitted by an advertising channel is not set.

In the wireless communication system, the configuration of the antenna or the setting of the device such as the connection interval may be changed based on the wireless transmission environment. In some cases, communication may be intentionally disconnected for change, and reconnection may need to be performed after the disconnection. In this case, similarly, the processor 32 can perform reconnection in a short time.

The communication device 28 receives an advertising signal transmitted from each wireless device 12. Advertising signals are needed at the time of initial connection and reconnection. At this time, the number and/or frequencies of the advertising channels used for reconnection may be included in an advertising signal and informed from a wireless device 12 to the wireless communication device 10. By this configuration, necessary scan windows can be assuredly set at the time of initial setting and reconnection.

The processor 32 performs communication with a wireless device 12 whose connection is determined. The processor 32 may notify the wireless device 12 of the number and/or frequencies of advertising channels used for reconnection by adding them to this communication. By this configuration, necessary scan windows can be assuredly set at the time of initial setting and reconnection.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication device comprising:
a communication unit configured to periodically communicate with wireless devices in first periods; and
a processor configured to determine whether a first wireless device of the wireless devices is connected to the wireless communication device, and when the processor determines that the first wireless device is not connected to the wireless communication device, the processor is configured to switch a reception frequency of the communication unit among frequencies in a second period having a length equal to a length of the first periods, and restart periodic communication with the wireless devices by the communication unit after the communication unit receives an advertising signal transmitted from the first wireless device.

2. The wireless communication device of claim 1, further comprising a memory configured to store respective identifiers of the wireless devices.

3. The wireless communication device of claim 1, wherein
the processor is configured not to perform communication with the wireless devices other than the first wireless device by the communication unit until the communication unit receives the advertising signal.

4. The wireless communication device of claim 1, wherein
the processor is configured to transmit a connection request signal to the first wireless device by the communication unit after receiving the advertising signal.

5. The wireless communication device of claim 1, wherein
the frequencies comprises m frequencies; and
the processor is configured to sets a reception frequency of each of m sub-periods included in the second period to one of the m frequencies.

6. The wireless communication device of claim 5, wherein
a time length of each of the sub-periods is one-mth of the first period.

7. The wireless communication device of claim 5, wherein
time lengths of the m sub-periods are different from each other.

8. The wireless communication device of claim 5, wherein
a time length of each of the m sub-periods is equal to the time length of the first period or different from the time length of the first period.

9. The wireless communication device of claim 1, wherein
the frequencies comprises m frequencies;
the processor is configured to set a reception frequency of each of m sub-periods included in the second period to one of the m frequencies; and
a time length of each of the sub-periods is one-(k×m)th of the time length of the first period, where k is an arbitrary positive integer greater than or equal to two.

10. The wireless communication device of claim 1, wherein
the processor is configured to determine that the first wireless device is not connected to the wireless communication device when a response from the first wireless device is not received for a certain period.

11. The wireless communication device of claim 1, wherein
the processor is configured to determine that the first wireless device is not connected to the wireless communication device when a disconnection request signal from the first wireless device is received.

12. The wireless communication device of claim 1, wherein
the processor is configured to determine that the first wireless device is not connected to the wireless communication device when an error is detected.

13. The wireless communication device of claim 1, wherein
the wireless communication device receives data and the advertising signal from the wireless devices.

14. The wireless communication device of claim 1, wherein
the communication unit is configured to transmit information related to the frequencies to the first wireless device.

15. The wireless communication device of claim 1, wherein
the processor is further configured to determine whether a second wireless device of the wireless devices is connected to the wireless communication device; and
when the processor determines that the first wireless device and the second wireless device are not connected to the wireless communication device, the processor is configured to switch the reception frequency of the communication unit among the frequencies in the second period, and restart periodic communication with the wireless devices by the communication unit after the communication unit receives the advertising signal transmitted from the first wireless device and an advertising signal transmitted from the second wireless device.

16. A wireless communication system comprising:
wireless devices; and
the wireless communication device of claim 1.

17. The wireless communication system of claim 16, wherein
when one of the wireless devices is configured to determine that the one of the wireless devices is not connected to the wireless communication device, the one of the wireless devices is configured to transmit the advertising signal to the wireless communication device by one of the frequencies, and
the processor is configured to set a frequency of the communication unit to a frequency other than the frequencies after the communication unit receives an advertising signal transmitted from the first wireless device.

18. A wireless communication method comprising:
periodically communicating with wireless devices in first periods;
determining whether a first wireless device of the wireless devices is connected to a wireless communication device;
when it is determined that the first wireless device is not connected to the wireless communication device, switching a reception frequency of a communication unit among frequencies in a second period having a length equal to a length of the first periods; and
restarting periodic communication with the wireless devices by the communication unit after the communication unit receives an advertising signal transmitted from the first wireless device.
